(19) United States
(12) Patent Application Publication
(10) Pub. No.: US 2012/0296795 A1
(43) Pub. Date: Nov. 22, 2012

(54) METHODS AND SYSTEMS FOR MATCHING BUY AND SELL ORDERS

(75) Inventor: Hannes Greim, Mount Pleasant, SC (US)

(73) Assignee: CITIGROUP GLOBAL MARKETS, INC., New York, NY (US)

(21) Appl. No.: 13/112,845

(22) Filed: May 20, 2011

(51) Int. Cl. G06Q 40/00

(52) U.S. Cl. 705/37

(57) ABSTRACT

Methods and systems for matching buy and sell orders that maximize the number of shares matched while simultaneously providing an even allocation of shares regardless of when a given order is received, are provided herein. The methods and system utilize an optimization function to determine the optimized price point at which the maximum number of shares can be matched using such inputs as a set of buy and sell orders, market spread, and participant defined exclusion criteria. This optimized price point may then be used to select those buy and sell orders eligible for participation in the matching event. Shares are then evenly allocated between participants using, for example, a round-lot base allocation procedure. The methods and systems may also utilize an anti-gaming function that compresses multiple orders from a single participant into a single participant interest prior to allocating shares.

### FIELD OF THE INVENTION

The present invention relates generally to the field of electronic commerce, and more particularly to methods and systems for matching buy and sell orders as evenly as possible to qualifying participants, whose qualification is based on parameters for the respective participants' orders.

### BACKGROUND OF THE INVENTION

Currently, most matching or crossing engines are based on a time-price priority principle. Orders are essentially sorted by their price, and then within a certain price level, by the time at which the order arrived at the venue. Thus, at a given price, the top priority for being matched with another order is generally given to the order that arrived first, referred to as time-price priority or first-in-first-out. Further, available matching algorithms match orders without considering whether two or more of such orders on a given side belong to the same participant, which may enable participants to game the matching process. There is a present need for a matching engine that optimizes a price point and provides an in-line, single pass optimization at the time of matching and identifies those orders, in advance, that are able to interact with one another to generate the maximum number of shares matched, while at the same time minimizing gaming of the process by participants.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform methods and systems for performing matching buy and sell orders described herein. In an embodiment of the invention, using a microprocessor, buyer-side and sell-side share orders are selected to participate in a matching event based at least in part upon an eligible pricing range of each order within a current market spread. In certain exemplary embodiment, the buyer-side and sell-side share orders may further comprise exclusion criteria. The exclusion criteria may be based on a categorical exclusion criteria, or may be based on a specific exclusion criteria. Exemplary categorical exclusion criteria may be based on a corporate profile, such as retail, or trading behavior, such as high frequency. Exemplary specific exclusion criteria may be based on a specific counter-party, where the counter-party can be identified directly or anonymously through a previous trading event.

Using the microprocessor, an optimized price point within a given market spread is determined that maximizes the number of shares matched in a matching event given a plurality of buyer-side and seller-side orders. In certain exemplary embodiments, the optimize price point is determined using a single pass, non-iterative optimization process. The single pass, non-iterative optimization process may involve defining legitimate price points for shares in each buyer-side and sell-side order. The optimization process may also include generating an array of available shares for each order at each of the defined price points within, for example, a near-peg and far-peg pricing parameter that maps a size matrix to the defined price point. In addition, the optimization process may include mapping for each order on a given side an aggregated volume of shares available to each of a plurality of counter-parties based on the size matrix and an exclusion matrix for each counter-party. The optimization process additionally includes, for example, determining a maximum number of shares that can be matched at each price point based on the mappings, determining a price point nearest a mid-spread at which each maximum number occurs, and outputting a price-point within the market spread that maximizes the shares matched.

The optimized price point is then used to filter the initial buyer-side and seller-side orders to select those whose acceptable price range includes the optimized price point. As an anti-gaming measure, the filter process for embodiments of the invention may be combined with a compressing function whereby all orders from a single participant are compressed into a single participant interest.

Available shares are then mapped between the seller-side and buyer-side orders or interest, taking into account any applicable exclusion criteria. An even allocation may be achieved using a round-lot base allocation. The round-lot base allocation may be a function, at least in part, of the cumulative shares available on one side and the number of qualifying participants on the opposite side. In embodiments of the invention, the base allocation is recalculated during mapping of the available shares to reflect a change in the base allocation as participant's interest are filled or exceeded. After the shares have been allocated, the shares are distributed between the corresponding orders. In instances where multiple orders from a single participant were compressed into a single interest, those interest are reformatted to individual orders at distribution.

In embodiments of the invention, mapping the available shares may comprise selecting an outer (M) loop and an inner (N) loop of orders, respectively, as defined based on which of the selected buyer-side or sell-side orders has a lesser or a greater cumulative size, the outer (M) loop having the lesser cumulative size and the inner loop (N) having the greater cumulative size. The outer loop (M) is sorted from largest to smallest order size, and the inner loop (N) is sorted from smallest to largest order size, using the microprocessor. Also using the microprocessor, the outer loop (M) is iterated from largest to smallest order on the outer loop (M) to match against orders on the inner loop (N) from smallest to largest order on the inner loop (N) using a round-lot base allocation to be distributed to each (N)-side participant. Thereafter, the microprocessor is used to iterate on the inner loop (N) from largest to smallest order on the inner loop (N), attempting to distribute the base allocation to each (N)-side participant. Using the microprocessor, (M)-side-to-(N)-side matched shares are mapped.

In embodiments of the invention, the round-lot base allocation to be distributed to each (N)-side participant in iterating on the outer loop (M) is calculated, for example, according to the number of (N)-side participants with at least a round-lot remaining and no exclusions toward the M-side order. In iterating on the inner loop (N), after filling an order of an (N)-side participant that is less than or equal to a current round-lot base allocation, the base allocation is recalculated for all remaining (N)-side participants with at least a round-lot remaining and no relevant exclusions. If there are shares remaining on the (M)-side orders, any round-lots remaining are distributed to (N)-side participants based on how many extra round-lots have already been distributed to an (N)-side participant compared to extra round-lots distributed to the other (N)-side participants. Once the (M)-side iterations are complete, if there are still shares remaining on the (M)-side orders, any remaining odd-lots from the (M)-side orders are distributed by matching enough shares of the remaining odd-lot orders on the outer (M) loop to accumulate a round lot and giving priority to (N)-side participants that have received less of the additional round-lot distributions in the preceding step before moving on to the next (N)-side participant.

The (M)-side-to-(N)-side mapping of matched shares may be converted to a buy-to-sell order mapping of matched shares and the buy-to-sell order mapping of matched shares may be output.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a schematic diagram, which illustrates an overview example of a crossing engine for embodiments of the invention;

FIG. 2 is a flow diagram that illustrates an example of the process of participation optimization for embodiments of the invention; and

FIG. 3 is a flow diagram that illustrates an example of a matched allocation process for embodiments of the invention.

### DETAILED DESCRIPTION

Reference will now be made in detail to embodiments of the invention, one or more examples of which are illustrated in the accompanying drawings. Each example is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

Currently, most matching or crossing engines are based on a time-price priority principle. That means that orders are essentially sorted by their price, and then within a certain price level, by the time at which the order arrived at the venue. Thus, at a given price, the top priority for being matched with another order is generally given to the order that arrived first. That is what is referred to as time-price priority or first-in-first-out.

Embodiments of the invention do not operate on such a time-price priority basis. This provides a significant advantage over such currently available crossing or matching systems. While in some cases, all other things being equal, the oldest order (i.e., the first order to arrive) may have some degree of priority, priority is relatively insignificant in the matching process for embodiments of the invention.

Embodiments of the invention propose methods and systems for matching buy orders and sell orders that match shares as evenly as possible to all of the qualifying participants. Participants' qualification is based on the parameters for the respective participants' orders. A current problem is that every buy order and sell order has certain qualifying attributes. One such attribute is the price point or portion of the spread of the market in which a buyer or a seller is willing to participate. Another qualifying attribute is the type or types of participants with which buyers and sellers are willing to interact.

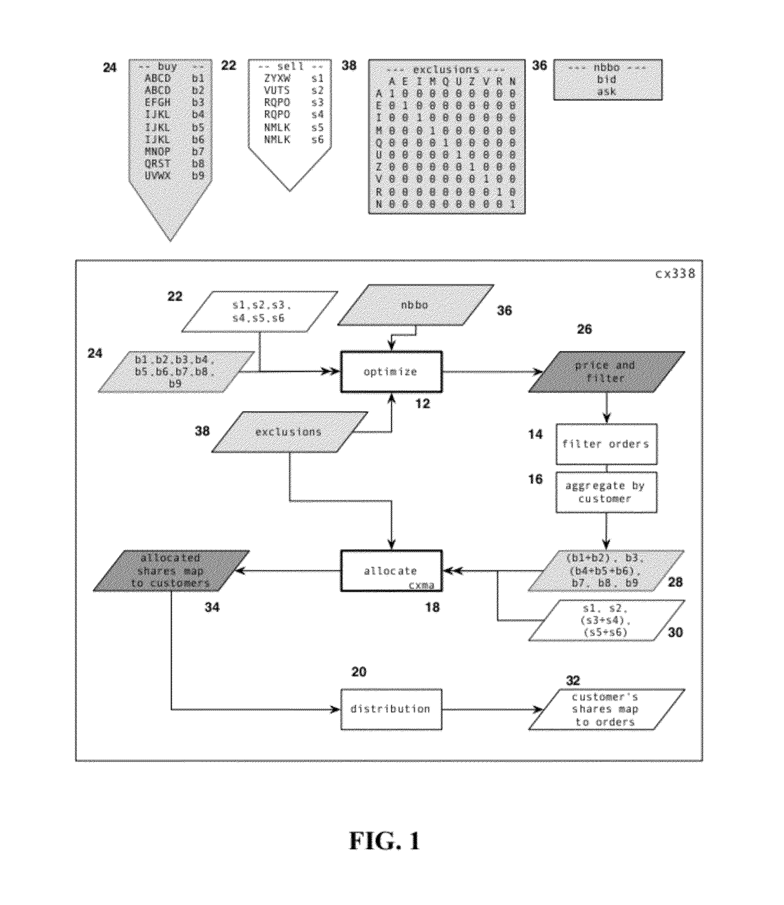

FIG. 1 is a schematic diagram which illustrates an overview example of a crossing engine for embodiments of the invention. Referring to FIG. 1, the crossing engine 10 may employ a single pass, in-line optimization algorithm 12 to determine an optimized price point at which the maximum number of shares can be matched. This optimized price point can then be utilized by a filter 14 to select those participants on a given book best positioned to match at the optimized price point. An aggregation function 16 may also be employed to condense multiple buy or sell side orders from a single participant into a single participant interest. Collectively, the optimization algorithm 12, filter 14, and optionally, the aggregation function 16 may be considered to constitute the participant optimization phase of the crossing engine 10. In addition, the crossing engine 10 may also employ a share-to-participant algorithm 18 with a share matching function designed to as evenly as possible allocate the available shares regardless of when each order was received. A participant-to-order distribution function 20 is then used to distribute the allocated shares to the individual orders. A goal of the crossing engine 10 is to simultaneously maximize the number of shares matched in a matching event while providing as even an allocation of shares as possible to each participant.

In embodiments of the invention, the process of selecting participants takes into consideration, for example, the eligible pricing range of each order within the current market spread (i.e., the gap between bid and asked prices) and each participant's exclusion criteria and the resulting impact on the number of shares crossed. In a particular context, the spread may be the national best bid and offer (NBBO) difference as currently defined in applicable U.S. Securities and Exchange Commission regulations. Within the spread in which a participant is willing to participate, the participant can set pricing criteria at which the participant would prefer to buy or sell. The participant may declare an absolute maximum or minimum “limit price,” or may not declare such a limit, making it a market order. The participant can also declare a range, or subset of the market spread, that is relative to the variable market spread, in which the order is eligible for participation.

Obviously, a buyer would typically prefer to buy at the lowest price possible. However, the buyer may be willing to buy a particular security at a price up to some percentage of the current NBBO, regardless of where the NBBO may currently be. When attempting to match orders, one of the parameters that determine whether a particular order can interact with other orders and how well it can interact with those orders is the pricing parameter for the particular order.

At least some degree of flexibility is allowed within the crossing engine 10 for embodiments of the invention as to where to execute a cross. Assume, for example, that the spread is 10 cents. In one embodiment, an order may be crossed anywhere inside that 10-cent spread. An objective is to cross the order at a point at which the maximum number of shares is crossed.

A unique aspect to the crossing engine 10 for embodiments of the invention is the optimization process 12 that performs a type of single pass in-line optimization based on all of the orders and their parameter sets to determine which price point will cause the most participants to qualify to generate the greatest number of shares matched.

When books of buy orders 22 and sell orders 24 are received by the crossing engine 10, each of those buy or sell orders may have attributes that relate to their exclusions, as well as to their pricing parameters. Pricing parameters may include, for example, an absolute limit price (i.e., an order to buy or sell at a specific price or better) or the participant's participation cone or accepted participation range within the market. The buy and sell orders may also include exclusion attributes that limit the types of counter parties with which they will interact. Exclusion criteria may include, for example, one or more participants with which a particular participant is unwilling to trade. A participant may be, for example, a trader, a trading desk, an entire brokerage, or an entire company. For example, one participant may exclude another participant, or two participants may exclude each other. However, if neither of the two participants excludes the other, a match can be performed between the two participants.

Another type of exclusion criteria may be a categorical exclusion based, for example, on a type of business, such as retail or principal. The categorical exclusions may be defined in different ways. For example, exclusion categories may be based on a corporate profile, such as institutional participants or hedge funds. Exclusion categories may also be based, for example, on actual trading behavior, such as high-frequency traders.

Still another type of exclusion is a specific exclusion, which may have, for example, two aspects. In one such aspect, a participant “A” may say in advance, for example, “I have no idea if participant “Z” is one of your participants, but if they are, I do not want to trade against them.” A response to participant “A” may be, “Okay, without telling you whether or not participant “Z” is one of our participants, we will ensure that you will not trade against them.”

In an anonymous specific exclusion aspect, a participant “A” may say, for example, “Whomever I was just trading against in this symbol at this time, I really do not like what is going on there. Please do not let me trade against them again.” A response to participant “A” may be, “Certainly, the participant you were trading against in that situation will be excluded in the future” without revealing who the participant was. Thus, exclusions may be offered both anonymously and specified, and categorical exclusions that are based on trading activity and/or corporate or business profile may also be offered.

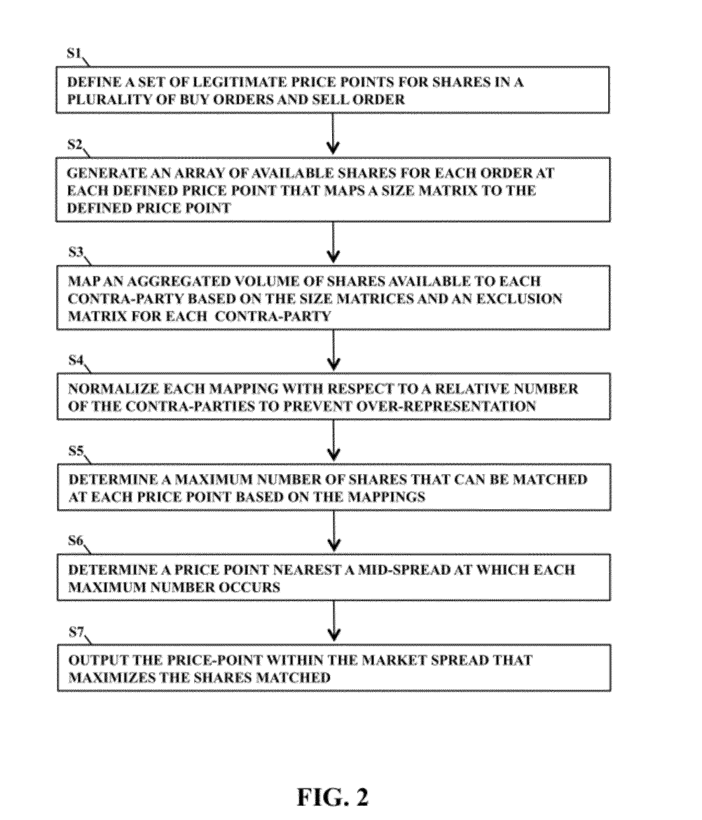

FIG. 2 is a flow diagram that illustrates an example of the single pass in-line optimization process for embodiments of the invention. Referring to FIG. 2, in the optimization aspect, given a current inside market (i.e., the highest quoted bid and the lowest offer price among competing market makers in a security) and the price granularity of a specific symbol (i.e., a particular security), typically, for example, $0.001 or a relative interval of the spread (e.g. 1/10th), at S1, a set of legitimate price points 26, as shown in FIG. 1, may be defined.

Referring further to FIG. 2, at S2, for each order, an array of available shares at each of the defined price points within a near-peg and far-peg pricing parameter of the order may be generated (the peg being the predetermined price level). The peg price parameters may be a fraction of the spread (in the interval [0.0,1.0], with, for example, a granularity of 0.1). The far-peg price parameter may be an indication of how aggressively the order is priced. For example, a far-peg price parameter of 0.5 indicates “pegged to mid-spread”. The near-peg price parameter may be an indication of the minimum level of aggressiveness for the pricing of the order. The set of arrays of the available shares for each order on a given side to all orders on the opposite side forms a set of matrices, which map the shares to price points for that side. These matrices may be referred to as buy-size and sell-size matrices.

Referring again to FIG. 2, at S3, the dot-product of an exclusion matrix with a size matrix may yield a mapping of the aggregated volume available to each counter-party for a given side. Since the summations of these respective output mappings may be compared (buy to sell) for share maximizations, at S4, the output mappings may be normalized with respect to the relative number of the contra-party participants to prevent over-representation.

Among all of the price points with overlapping size interest as represented in the normalized buy and sell side mappings, the lesser between the two aggregated sides represents the greatest number of shares that can be matched at each of those price points. Referring once more to FIG. 2, at S5, the greatest of these lesser-of-the-pair sizes may be determined, which represents the most shares that can be matched in a given price interval. At S6, the price point nearest to mid-spread at which these maxima occur may be identified, and at S7, the price-point within the market spread that maximizes the shares crossed may be output. The orders eligible to participate in the matching event are all those eligible for that price-point.

Considering all of the participant factors, embodiments of the optimization phase of the present invention optimize a price point and identify, as part of the overall matching process, those participants who are able to interact with one another to generate the maximum number of shares crossed.

In embodiments of the invention, the cross engine 10 receives a buy book and sell book from an order management system. The cross engine 10 performs optimization of participants and distribution in various functions. The cross engine 10 returns a list of orders from the initial set that was received, together with a number of shares for each order that was filled as well as the execution or matching price. Thus, the in-line participant optimization function 12 and the share-to-participant allocation 18 are uniquely two functional parts or steps of a single streamlined matching process, without a specific demarcation between the two functions.

The inputs into the crossing engine 10 for embodiments of the invention are buy orders 22 and sell orders 24, with their relevant parameters; a market spread 36, such as the NBBO; and an exclusion matrix 38, which defines which counter parties are allowed to interact with each other. The optimization function 12 determines an optimized price point 26 at which the match will be executed. It is the price point selected within the spread that is closest to the mid spread but still maximizes the cumulative volume of the candidate participants (i.e. overall matching potential.). The filter 14 selects those participants from the original buy and sell orders eligible to participate based on the optimized price point.

An anti-gaming aggregate function 16 may also be employed to condense multiple buy or sell orders from a single participant into a single participant interest. It is possible, for example, for a participant to have multiple orders on the buy side of the book. In order to prevent such a participant from gaming the system and being overrepresented in the share allocation process, once the optimization function is performed, all of the resulting qualifying orders are compressed, by client, as a single representation of a “buy interest” set.

Orders may then be matched without considering whether or not two or more of such orders belong to the same participant. As an example, assume two sellers each of whom wants to sell 1,000 shares and one buyer that wants to buy 1,000 shares. A prior art first-in-first-out matching system simply matches the buyer's order with the first seller's order, leaving the other seller's order totally unfilled. A fair allocation may simply divide those shares as evenly as possible within certain constraints, and allocate five hundred shares to each of those selling orders. However, simply dividing the shares presents an opportunity to game the crossing engine 10 because, in the same scenario, a savvy seller can submit, for example, four orders to sell 1,000 shares each. Thus, the savvy seller has submitted four 1,000 share orders, the innocent seller has the single 1,000 share order, and the same buyer wants to buy 1,000 shares. Applying the same principle of simply dividing those orders evenly results in distributing one fifth of the 1,000 share buy order to each of those sell orders. Thus, the savvy seller is allocated four times as many shares as the innocent seller. In order to prevent such gaming of the distribution mechanism, embodiments of the invention compress the interest on each side by entity so that each seller receives one half of the buyer-side interest. The compression stage for embodiments of the invention is unique in condensing the orders based on the interests of each participant and performing an allocation function based on that compression.

The filter function 14 may produce a list of executable orders and aggregation function 16 may produce a list of compressed side-specific participant interests 28 and 30, reflecting all of the individual orders for a single participant, thereby optimizing the number of shares to be matched based, for example, on an available price range of each order, and exclusions, such as categorical exclusions or specific exclusions of each order.

The share-to-participant allocation process 18, then takes the compressed, side-specific interest 28 and 30 and maps an even allocation of shares between participants, for example, by evenly mapping the allocation of shares from the seller-side orders to the buyer-side orders. Even allocation among participants may follow a per capita basis, wherein each participant receives the same amount of shares, up to their individual request, instead of following a pro rata basis (i.e. allocation based on requested share size) or the chronological order in which the orders were received. The share-to-participant allocation process may use a round-lot base allocation function. The round lot allocation is based, at least in part, on the cumulative number of shares available and the number of buyer-side orders. The share-to-participant allocation algorithm 18 is designed to update the base allocation number inline as individual buyer-side orders are filled or exceeded, ensuring even distribution of remaining shares is achieved. The share-to-participant allocation may be achieved using an iterative process or utilizing linear algebra techniques.

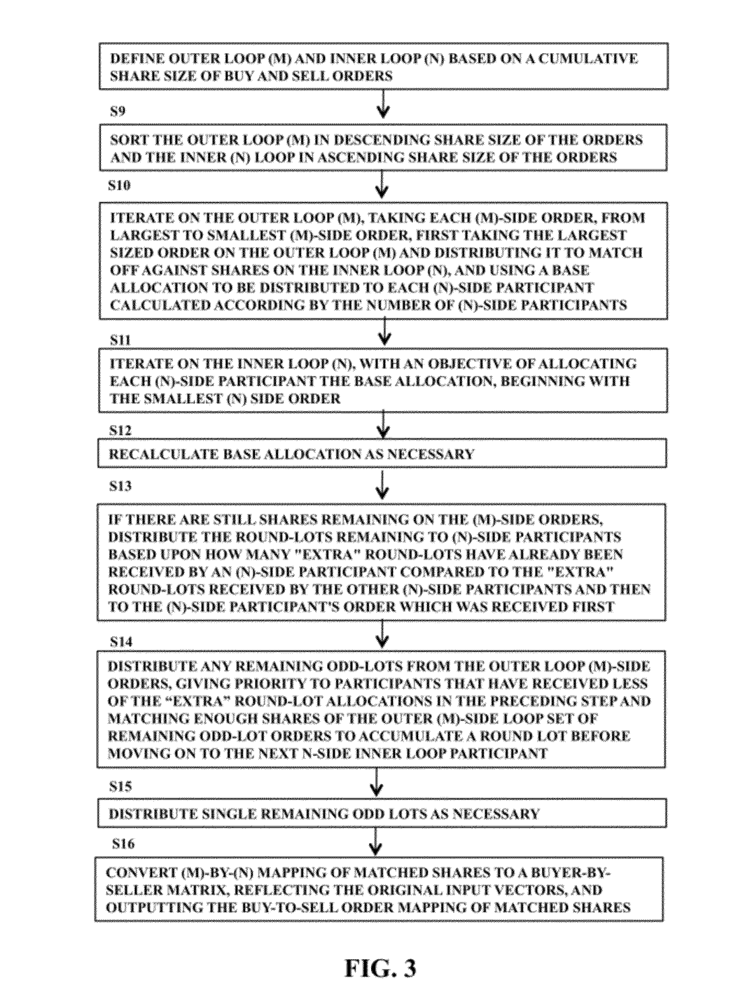

FIG. 3 is a flow diagram that illustrates an example of the share-to-participant process 18 for embodiments of the invention. Referring to FIG. 3, at S8, outer (M) and inner (N) loops may be defined based on a cumulative share size of buy and sell orders. In other words, the outer (M) and inner (N) iterators may be defined based on which side has a lesser (M) or a greater (N) cumulative size. If the cumulative number of shares for all orders on the buy side is less than or equal to the cumulative number of shares for all the orders on the sell side, the buy side may be treated as the outer loop (M), and the sell side may be treated as the inner loop (N). Otherwise, the sell side may be treated as the outer loop (M), and the buy side may be treated as the inner loop (N).

Referring again to FIG. 3, at S9, the (M) and (N) loops may be sorted based on descending and ascending order size, respectively. Thus, the outer iterator (M) is sorted from largest to smallest order size, and the inner iterator (N) is sorted from smallest to largest order size. The outer loop (M) is the side that sums up to fewer shares than the inner loop (N). Thus, it is expected that the outer loop (M) will end up being completely matched against the inner loop (N). However, unmatched shares may remain due to un-reconcilable exclusions between the parties. These unmatched orders may be returned to the booking engine for use in a later matching event. Once it is determined which is the outer loop (M) and which is the inner loop (N), the orders on each side may be sorted. The outer loop (M), which is the side with the lesser number of overall shares, is sorted such that the first order is the largest order on that side.

Referring further to FIG. 3, at S10, iteration may be performed on the outer loop (M), taking each (M)-side order, from largest to smallest (M)-side order. Iteration begins through the outer loop (M), thus first taking the largest sized order on the outer loop (M)-side and distributing it to match off against shares on the inner loop (N)-side. A round lot is a number of shares defined as a multiple of a number, such as 100. For purposes of this discussion, a round lot is deemed to be 100 shares. The round-lot base allocation to be distributed to each (N)-side participant for the current iteration of the (M)-side may be calculated by determining the number of candidate participants, assuming that the (N)-side participant has at least a round-lot and has no exclusions, categorical or specific, against the (M)-side participant. In this way, the round-lot base allocation to be distributed to each participant that has at least a round lot remaining and is not subject to an exclusion against the order being distributed is calculated.

Referring still further to FIG. 3, at S11, iteration may be performed on the inner loop (N), with an objective of each qualifying (N)-side participant being allocated the base allocation, starting with the smallest. Thus, the iteration is performed through each remaining participant on the opposite side that has no exclusions against the order being distributed. If a participant has fewer remaining shares than the base allocation, the round-lot portion of the participant's remaining shares is allocated.

After filling the order of the participant with a “less than or equal to” current base allocation, the base allocation may be recalculated at S12 for all remaining (N)-side participants with at least a round-lot remaining. In other words, if the participant has less than or the same size as the base allocation, the round-lot portion of the order is filled and the base allocation is recalculated. Otherwise, the base allocation may be distributed to the participant.

Referring once more to FIG. 3, if there are still shares left on the current (M)-side order, at S13, the number of round-lots available may be determined and distributed based upon whether the (N)-side participant is eligible (e.g. there is no exclusion against the (M)-side order), how many “extra” round-lots have already been received by the (N)-side participant compared to the “extra” round-lots received by the other eligible participants, and (all else being equal) which (N)-side participant's order was received first.

An odd lot is a number of shares less than a round lot. Referring again to FIG. 3, at S14, any remaining odd-lots from the outer loop (M)-side orders may be distributed, giving priority, for example, to participants that have received less of the additional round-lot allocations in the preceding step S13 and matching enough shares of the outer (M)-side loop set of remaining odd-lot orders to accumulate a round lot before moving on to the next N-side inner loop participant.

Recall, for example, from the step S9 that the outer loop (M) has the smaller overall size sorted in descending order from largest order down to smallest order. Assume 1,000 shares as a current buy order and three participants on the sell side. The base allocation is 300 shares. If each participant on the sell side is allocated 300 shares out of that 1,000 shares on the buy side, participants on the sell side have each been given an even allocation without generating any kind of round lots.

Beginning with base allocation shares, 300 shares are allocated to the first participant on the sell side, the next 300 shares to the next participant on the sell side, and the next 300 shares to the third participant on the sell side.

Since the sell side was sorted by ascending size order, it is possible to immediately have an order in the inner loop (N) that is less than the base allocation. If that is the case, it is possible to simply fill in the amount represented by that order and immediately recalculate the base allocation. For example, 1,000 shares buying and three sellers, sorted in ascending order as a 200-share order, a 1,000-share order, and a second 1,000-share order. The base allocation is 300 because there are three participants on the other side, and 300 is the largest number that can be distributed evenly.

Turning first to the 200-share order, since the first seller has only 200 shares to sell, all of the first seller's shares are allocated. That leaves 800 shares to be allocated between the second and third sellers. The base allocation is recalculated based on the two remaining qualifying sellers, so each one of them is allocated 400 shares.

Returning to the example with one buy order of 1,000 shares and three sell orders of 1,000 shares each. The base allocation is 300 shares. Stepping through the inner loop (N), 300 shares are allocated to each of the three sell orders, which leaves 100 shares remaining. When the order being distributed has shares remaining, the number of round lots left (i.e., one round lot in this example) are distributed to each participant that has at least a round lot remaining, is not subject to any exclusion, and has not already received a round lot. Since this example is a first cut through the inner loop (N), no participant has received an extra round lot. Therefore, the 100 shares are allocated to the first sell order.

Assume in the above example that the buy order actually has 1012 shares instead of 1,000 shares. The same process is followed but there are now twelve shares remaining. Those twelve remaining shares are not addressed immediately. Instead, the next order on the outer loop (M) is processed. Again, the goal is to maximize the number of shares that can be distributed without creating odd lots. That would also mean not taking an odd lot and matching it across the other side unnecessarily.

Assume also that the outer loop (M) iteration has been performed for all of the buy orders. It is now time to determine if there are any odd lots left. In the present example, there are at least twelve shares from the first buy order remaining. At S15, all of the such odd lot orders left on the buy side can be aggregated to begin making round lots again and to distribute them, based on the same principle by which the round lots were distributed inside the inner loop (N). An object is to fill up a round lot with the remaining odd lots, and whoever has received the least number of extra round lots that still qualifies is allocated that round lot.

For a scenario in which less than all participants are matched with an equal number of round lots, those participants that have obtained an “extra” round lot will not be candidates to obtain an additional “extra” round lot until all other candidates have obtained an equal number of “extra” round lots. When there is an extra round lot resulting, for example, from the effort to avoid creating odd lots, the extra round lot is allocated to the first candidate that qualifies that has not already received a round lot in a previous consideration. Finally, if there is only an odd lot remaining, it is distributed in the same manner.

A mixed lot is a combination of round and odd lots. While odd lots and mixed lots are allowed, an allocation of an odd lot portion can be characterized as a secondary path through the system. As many shares as possible are distributed in a round lot manner. When that is accomplished, if there are odd lots left, odd lots will be matched until one side is completely filled. Thus, the creation of odd-lots or mixed-lots is minimized.

The creation of odd lots or mixed lots is avoided where possible. For example, assume there are 1,000 shares buying and three sellers, each with 1,000 shares. In order to avoid creating a mixed lot by giving each seller 333 shares, one seller is allocated 400 of the 1,000 shares buying, and the other two sellers are each allocated 300 shares of the 1,000 shares buying.

An output may be a mapping 34 of how many shares were matched between every buyer and seller, but such information is not necessarily published by the crossing engine 10. It may be useful for internal analysis to know, for example, how many shares of participant “A” matched participant “B”. However, the important output is derived from the mapping and is essentially the summation across the row or column of the matrix for each buyer and seller correspondingly. The crossing engine 10 outputs a number of shares each participant is allocated, which is then distributed into actual order forms 32 from each participant.

At S16, the (M)-by-(N) mapping of matched shares may be converted to a buyer-by-seller matrix, reflecting the original input vectors of participant interest, and the buy-to-sell participant interest mapping of matched shares 32, as shown in FIG. 1, may be output to complete the match. In instances where multiple orders from a single participant were compressed into a single participant interest, those interest are re-formatted back to individual orders.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein. Those skilled in the art will recognize that the present invention may be implemented in either a stand-alone, or in a distributed computing environment, or both. In a distributed computing environment, program modules and functions may be physically located in different local and remote memory storage devices.

It is also to be understood that such computer-readable media may include, but are not limited to, electronic, optical, magnetic, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. In certain embodiments of the present invention instructions may first be rendered in Matlab or comparable programming codes and later complied into suitable computer programming language. Suitable computer programming languages include, without limitation, C, C++, C#, Visual Basic, Java, Python, Perl, and JavaScript.

It is to be further understood that client devices that my be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

What is claimed is:

1. A method for matching buy and sell orders, comprising:
determining, using a microprocessor, an optimized price point within a market spread that maximizes the number of shares matched for a matching event given a plurality of buyer-side and seller-side orders wherein each order defines at least a number of shares and an acceptable price range criteria;
selecting, with the microprocessor, executable buyer-side and seller-side orders for a matching event by filtering the plurality of buyer-side and seller-side orders to select those orders eligible to participate based on the optimized price point;
evenly allocating shares between the executable buyer-side and seller-side orders, using the microprocessor, by mapping available shares between the seller-side and buyer-side orders based on a round-lot base allocation; and
distributing, using the microprocessor, the allocated shares from the seller-side orders to the buyer-side orders.

2. The method of claim 1, wherein at least one buyer-side or seller-side order defines an exclusion criteria.

3. The method of claim 2, wherein the exclusion criteria can be a categorical exclusion or a specific exclusion.

4. The method of claim 3, wherein the categorical exclusion is based on a corporate profile or trading behavior.

5. The method of claim 4, wherein the specific exclusion is based on a specific counter party, and wherein the counter party can be identified directly or anonymously through a previous trading event.

6. The method of claim 2, wherein the exclusion criteria is utilized when evenly allocating shares between executable buyer-side and seller-side orders.

7. The method of claim 1, wherein determining an optimized price point requires a single pass or non-iterative process.

8. The method of claim 7, wherein determining an optimized price point comprises:
defining, using the microprocessor, a set of legitimate price points based on a given market and price granularity of a specific symbol;
generating, using the microprocessor, an array of available shares for each order at each price point that maps a size matrix to a given price point;
mapping, using the microprocessor, an aggregated volume of shares available to each buyer-side order and seller-side order based on the size matrices and an exclusion matrix;
normalizing, using the microprocessor, each mapping with respect to the relative number of buyer and seller inputs;
determining, using the microprocessor, a maximum number of shares that can be matched at each price point based on the mappings;
determining, using the microprocessor, the optimized price point by identifying the price point nearest a mid spread at which each maximum occurs.

9. The method of claim 1, wherein the method further comprises compressing multiple buyer-side and seller-side orders from the same participant into a single buyer-side interest or seller-side interest.

10. The method of claim 9, wherein distributing the mapped shares comprises reformatting the mapped buyer-side interest and seller-side interest to individual buyer-side and seller-side orders.

11. The method of claim 1, wherein the round-lot base allocation is determined at least in part from the cumulative shares available from a side with the greatest aggregate number of shares, and the number of participants on a side with the lesser aggregate number of shares.

12. The method of claim 1, wherein the base allocation is automatically recalculated as to any remaining unfilled orders as buyer-side or seller-side orders are met or exceeded by the base allocation.

13. The method of claim 1, wherein evenly allocating the shares follows a per capita distribution.

14. The method of claim 1, wherein evenly allocating shares between the executable buyer-side and seller-side orders comprises mapping available shares between the seller-side and buyer-side orders based on a round-lot base allocation using linear algebra functions.

15. The method of claim 1, wherein evenly allocating the share comprises:
selecting, using the microprocessor, an outer (M) loop and an inner (N) loop of orders based on which of the selected buyer-side orders or seller-side orders has a lesser or greater cumulative size, the outer (M) loop having the lesser cumulative size and the inner loop (N) having the greater cumulative size;
sorting, using the microprocessor, the outer loop (M) from largest to smallest order size, and sorting the inner loop (N) from the smallest to largest order size;
iterating, using the microprocessor, on the outer loop (M) from largest to smallest order on the outer loop (M) to match against orders on the inner loop (N) from smallest to largest order on the inner loop (N) using the round-lot base allocation to be distributed to each (N)-side participant;
iterating, using the microprocessor, on the inner loop (N) from the largest to smallest order on the inner loop (N), attempting to distribute the base allocation to each (N)-side participant; and
mapping, using the microprocessor, (M)-side-to-(N)-side matched shares.

16. The method of claim 15, wherein iterating on the outer loop (M) further comprises iterating on the outer loop (M) to match against orders on the inner loop (N) using a round-lot base allocation to be distributed to each (N)-side participant calculated according to the number of qualifying (N)-side participants.

17. The method of claim 15, wherein iterating on the outer loop (M) further comprises calculating the round-lot base allocation to be distributed to each (N)-side participant with at least a round-lot remaining based on the number of qualifying (N)-side participants.

18. The method of claim 15, wherein iterating on the inner loop (N) further comprises after filling an order of an (N)-side participant that is less than or equal to a current round-lot base allocation, recalculating the base allocation for all remaining qualifying (N)-side participants with at least a round-lot remaining.

19. The method of claim 18, wherein if there are shares remaining on the (M)-side orders, distributing any round-lots remaining to (N)-side participants based on how many extra round-lots have already been distributed to an (N)-side participant compared to extra round-lots distributed to the other (N)-side participants.

20. The method of claim 19, wherein if there are still shares remaining on the (M)-side orders, distributing any remaining odd-lots from the (M)-side orders, giving priority to (N)-side participants that have received less of the additional round-lot distributions in the preceding step and matching enough shares of the remaining odd-lot orders on the outer (M) loop to accumulate a round lot before moving on to the next (N)-side participant.

21. The method of claim 1, further comprising converting the (M)-side-to-(N)-side mapping of matched shares to a buy-to-sell order mapping of matched shares and outputting the buy-to-sell order mapping of matched shares.

22. A system for matching buy and sell orders, comprising:
a microprocessor couple to memory, wherein the processor is programmed for:
determining an optimized price point within a market spread that maximizes the number of shares matched for a matching event given a plurality of buyer-side and seller-side orders, wherein each orders defines at least a number of shares and an acceptable price range criteria;
selecting participants for a matching event by filtering the plurality of buyer-side and seller-side orders to select those orders eligible to participate based on the optimized price point;
evenly allocating shares by mapping available seller-side shares to buyer-side orders based on a round-lot base allocation; and
distributing the mapped shares from the seller-side orders to the buyer-side orders.

23. A non-transitory computer-readable storage medium with an executable program for matching buy and sell orders stored thereon, wherein the program instructs a microprocessor to perform the following steps:
determining an optimized price point within a market spread that maximizes the number of shares matched for a matching event given a plurality of buyer-side and seller-side orders, wherein each order defines a number of shares and an acceptable price range criteria;
selecting participants for a matching event by filtering the plurality of buyer-side and seller-side orders to select those orders eligible to participate based on the optimized price point;
mapping shares by evenly allocating available seller-side shares to buyer-side orders based on a round-lot base allocation; and
distributing the mapped shares from the seller-side orders to the buyer-side orders.
